(19) United States
(12) Patent Application Publication
(10) Pub. No.: US 2007/0076894 A1
(43) Pub. Date: Apr. 5, 2007

(54) Audio control system

(75) Inventors: Shinichi Inoue, Saitama (JP); Shigeki Miyaji, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/524,188

(22) Filed: Sep. 21, 2006

(30) Foreign Application Priority Data
Sep. 30, 2005 (JP) 2005-287965

(51) Int. Cl. H04R 5/00

(52) U.S. Cl. 381/27; 381/18; 381/19

(57) ABSTRACT

To propose an audio control system in that even if it has a thin center speaker, low sounds can be felt to be heard from the center speaker. A low frequency signal in a center channel audio signal is delayed, and then the delayed signal is added to a right and a left channel audio signals, and they are transmitted to the corresponding left speaker and right speaker in the state where it is delayed from a high frequency signal in the above center channel audio signal. Thereby, a low sound based on the low frequency component in the center channel audio signal can be emitted as if it is emitted from a thin center speaker, by a phenomenon that sounds are heard as the position is deviated to the direction where there is the sound reached to the ears at first (HAAS effect).

### CROSS REFERENCES TO RELATED APPLICATIONS

The present invention contains subject matter related to Japanese Patent Application JP2005-287965 filed in the Japanese Patent Office on Sep. 30, 2005, the entire contents of which being incorporated herein by reference.

### BACKGROUND OF THE INVENTION

1. Field of the Invention

The present invention relates to an audio control system, and is suitably applied for example to a home theater system.

2. Description of the Related Art

Heretofore, a home theater system generally has a right and a left front speakers and a center speaker, and provides a sound field filled with presence similar to a movie theater by emitting reproduced sounds from these speakers.

In recent home theater systems, by demand for miniaturization, a tendency to use a thin center speaker is high. However, a thin center speaker generally has a tendency that low sounds become thin and it is hard to form a sound field with presence.

Here, as a technique to form a sound field with presence, it has been proposed that the phase of a specified frequency band in a low frequency component in a center channel audio signal is shifted, and the above phase-shifted low frequency component is added to both of a left channel audio signal and a right channel audio signal or either one of them (for example, refer to Japanese Patent Laid-open No. 2003-61198).

In this technique, the connection between low sounds emitted from a right and a left speakers can be improved through the phase adjustment of the specified frequency band. Thus, unnaturalness and dullness can be improved by sound orientation. As a result, a sound field with presence can be formed.

### SUMMARY OF THE INVENTION

In the above technique, it has been a problem that although the connection between low sounds emitted from a right and a left speakers can be improved, low sounds which should be properly emitted from a center speaker cannot be felt to be heard from the center speaker.

In view of the foregoing, it is desirable to provide an audio control system in that even if it has a thin center speaker, low sounds can be felt to be heard from the center speaker.

According to an embodiment of the present invention, there is provided an audio control system, in which an audio input section inputting a center channel audio signal, and a left channel audio signal and a right channel audio signal in an audio source, and an output control section controlling the output of the center channel audio signal to a center speaker, the output of the left channel audio signal to a left speaker, and the output of the right channel audio signal to a right speaker are provided. In the above output control section, a first filter section extracting a high frequency signal from the center channel audio signal, a second filter section extracting a low frequency signal from the center channel audio signal, and a signal separating and adding section separating the low frequency signal, and adding the above separated one to the left channel audio signal and also adding the above separated other to the right channel audio signal are provided.

Therefore, in this audio control system, by a phenomenon that sounds are heard as the position is deviated to the direction where there is the sound reached to the ears at first (HAAS effect), a low sound based on the low frequency component in the center channel audio signal can be emitted as if it is emitted from the thin center speaker.

Further, in the above output control section, a delay section delaying the low frequency signal extracted by the second filter section is further included. The above low frequency signal is added to the left channel audio signal and the right channel audio signal after separated, and the resultant signals are transmitted to the corresponding left speaker and right speaker in the state where it is delayed from the high frequency signal.

Accordingly, in this audio control system, the low frequency signal in the center channel audio signal can be transmitted to the corresponding left speaker and right speaker in the state where it is delayed from the high frequency signal in the center channel audio signal to be transmitted to the center speaker. Therefore, a low sound based on the low frequency component in the center channel audio signal can be emitted as if it is emitted from the center speaker in a normal using state, without making the user take into particular consideration to the positional relationship between the left speaker and the right speaker to the center speaker, the arrangement environment, and the like.

The nature, principle and utility of the present invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a block diagram showing an audio system according to this embodiment;

FIG. 2 is a schematic diagram showing the result of HPF processing; and

FIG. 3 is a schematic diagram showing the result of LPF processing.

### DETAILED DESCRIPTION OF THE PREFERRED EMBODIMENT

Preferred embodiments of the present invention will be described with reference to the accompanying drawings.

According to an embodiment of the present invention, a low sound based on a low frequency component in a center channel audio signal CAS can be emitted as if it is emitted from a thin center speaker CS, by a phenomenon that sounds are heard as the position is deviated to the direction where there is the sound reached to the ears at first (HAAS effect). Thereby, an audio control system in that even if it has a thin center speaker, low sounds can be felt to be heard from the center speaker can be realized.

(1) Overall Configuration of Audio Forming System according to this Embodiment

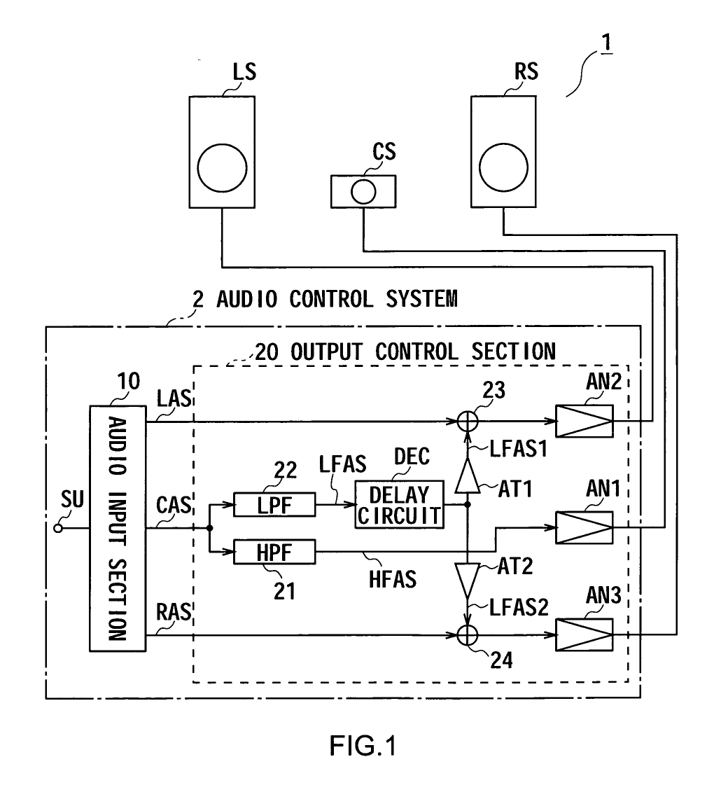

Referring to FIG. 1, the reference numeral 1 shows an audio forming system according to this embodiment as a whole. The audio forming system 1 has an audio control system 2, and a pair of left speaker LS and right speaker RS and a thin center speaker CS that are provided on the outside of the above audio control system 2.

(2) Configuration of Audio Forming System

In this audio control system 2, a center channel audio signal CAS, a left channel audio signal LAS and a right channel audio signal RAS in an audio source SU are entered by an audio input section 10. They are supplied to an output control section 20 serving as output controller.

This audio source SU also may be an optical disc such as a Digital Versatile Disc (DVD), a Compact Disc (CD) or a Blue-ray Disc (BD, Registered Trademark), also may be a recording medium provided in electronic equipment such as a personal computer, a cellular phone, a hard disk recorder or a portable audio player, and also may be broadcast waves or external sounds in various systems. Provided that a center channel audio signal CAS, a left channel audio signal LAS and a right channel audio signal RAS are included, it can be applied to the audio source SU.

Further, as the audio input section 10, a unit having a function to generate a center channel audio signal CAS, a left channel audio signal LAS and a right channel audio signal RAS from the audio source SU also may be applied. A unit having a function to input a center channel audio signal CAS, a left channel audio signal LAS and a right channel audio signal RAS that were generated in an external device also may be applied. And a unit having both these functions also may be applied.

Note that, as the function to generate a center channel audio signal CAS, a left channel audio signal LAS and a right channel audio signal RAS, concretely, a reproducing function to reproduce a center channel audio signal CAS, a left channel audio signal LAS and a right channel audio signal RAS from an optical disc or a recording medium in electronic equipment, and a take-in function to take in a center channel audio signal CAS, a left channel audio signal LAS and a right channel audio signal RAS from broadcast waves or external sounds, or the like are adopted. At least one or more these functions are adopted.

On the other hand, the output control section 20 transmits a center channel audio signal CAS to a High Pass Filter (HPF) 21 and a Low Pass Filter (LPF) 22, and transmits a left channel audio signal LAS to a first adder 23 and also transmits a right channel audio signal RAS to a second adder 24.

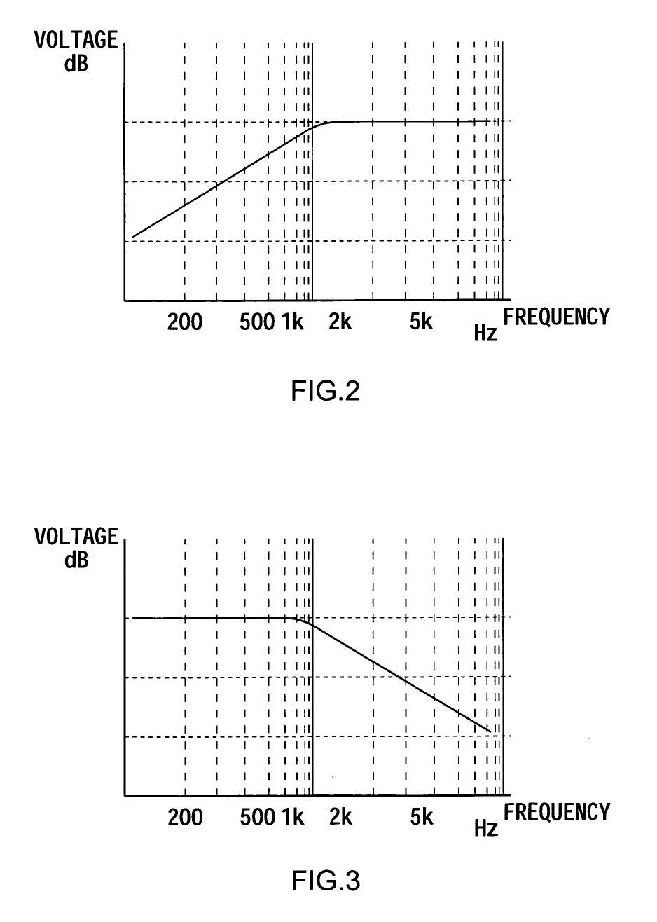

The HPF 21 performs HPF processing on the center channel audio signal CAS, and extracts a signal having a high frequency component such as shown in FIG. 2 (hereinafter, this is referred to as a center high frequency audio signal) HFAS. The center high frequency audio signal HFAS is amplified in an amplifier AN1, and the amplified signal is transmitted to the thin center speaker CS.

The LPF 22 performs LPF processing on the center channel audio signal CAS to extract a signal having a low frequency component such as shown in FIG. 3 (hereinafter, this is referred to as a center low frequency audio signal) LFAS, and transmits this to a delay circuit DEC. The center low frequency audio signal LFAS is delayed by the delay circuit DEC.

The delayed center low frequency audio signal LFAS is separated into a first center low frequency audio signal LFAS1 and a second center low frequency audio signal LFAS2 by attenuators AT1 and AT2. Then, the first center low frequency audio signal LFAS1 is added to the left channel audio signal LAS in the first adder 23, and then the resultant signal is amplified in an amplifier AN2. The amplified signal is transmitted to the left speaker LS. On the other hand, the second center low frequency audio signal LFAS2 is added to the right channel audio signal RAS in the second adder 24, and then the resultant signal is amplified in an amplifier AN3. The amplified signal is transmitted to the right speaker RS.

In this manner, in this output control section 20, the high frequency component of the center channel audio signal CAS is transmitted to the thin center speaker CS, and the above low frequency component is transmitted to the corresponding speaker LS, RS with the right or left channel audio signal LAS, RAS, in the state where it is delayed from the high frequency component.

As a result, in this audio forming system 1, a sound field in which a low sound based on the low frequency component in the center channel audio signal CAS is heard as if it is emitted from the thin center speaker CS, by a phenomenon that sounds are heard as the position is deviated to the direction where there is the sound reached to the ears at first (HAAS effect) is formed.

In addition to the above configuration, in the audio forming system 1, it is selected that a delay time corresponding to the distances between the thin center speaker CS and the left speaker LS, and the thin center speaker CS and the right speaker RS can be set. In this embodiment, it is selected that the above delay time can be set to 2 msec-10 msec.

Therefore, in the audio forming system 1, a sound field in which it is heard as if low sounds are emitted from the thin center speaker CS can be formed in a normal using state, without making the user take into particular consideration to the positional relationship between the left speaker LS and the right speaker RS to the thin center speaker CS, the arrangement environment, and the like.

(3) Operation and Effect of this Embodiment

According to the above configuration, the audio control system 2 in this audio forming system 1 extracts a high frequency signal (a center high frequency audio signal HFAS) from a center channel audio signal CAS in the audio source SU, and transmits this to the thin center speaker CS.

On the other hand, the audio control system 2 extracts a low frequency signal (a center low frequency audio signal LFAS) from the center channel audio signal CAS in the audio source SU, and then delays this.

Then, the audio control system 2 separates the delayed low frequency signal (the center low frequency audio signal LFAS), adds the above separated one to a left channel audio signal LAS in the audio source SU, and also adds the above separated other to a right channel audio signal RAS in the audio source SU. In this manner, the audio control system 2 transmits the signals to the corresponding left speaker LS and right speaker RS in the state where the low frequency signal is delayed from the high frequency signal.

Accordingly, in the audio control system 2, the low frequency signal in the center channel audio signal CAS can be transmitted to the corresponding left speaker LS and right speaker RS in the state where it is delayed from the high frequency signal in the center channel audio signal CAS to be transmitted to the thin center speaker CS. Thereby, a low sound based on the low frequency component in the center channel audio signal CAS can be felt to be heard as if it is emitted from the thin center speaker CS, by a phenomenon that sounds are heard as the position is deviated to the direction where there is the sound reached to the ears at first (HAAS effect).

Note that, in the technique shown in the above cited document 1, as it is obvious from that it aims to improve the connection between the low sounds emitted from the right and left speakers, the connection between the low sounds emitted from the right and left speakers can be improved when the phase of a specified frequency band in a low frequency band was shifted. However, low sounds cannot be felt to be heard from the thin center speaker CS. The thinner the thin center speaker CS becomes, the more remarkable it becomes.

In this manner, in the audio control system 2, low sounds can be emitted from the thin center speaker CS on the feeling of hearing, by actively delaying the overall low frequency band.

According to the above configuration, a low frequency signal in a center channel audio signal CAS is delayed, and then the resultant signal is added to a right and a left channel audio signals, and they are transmitted to the corresponding left speaker LS and right speaker RS in the state where it is delayed from a high frequency signal in the above signal CAS. Thereby, a low sound based on the low frequency component in the center channel audio signal CAS can be emitted as if it is emitted from a thin center speaker CS, by a phenomenon that sounds are heard as the position is deviated to the direction where there is the sound reached to the ears at first (HAAS effect). Thus, even if it is a thin center speaker, low sounds can be felt to be heard from the center speaker.

(4) Another Embodiment

In the aforementioned embodiment, it has dealt with the case where the output control section 20 having the delay circuit DEC is applied. However, the present invention is not only limited to this but also an output control section in which the above delay circuit DEC is omitted may be applied.

In this case, although the positional relationship between the thin center speaker CS and the left speaker LS, and the thin center speaker CS and the right speaker RS is specified in accordance with the arrangement environment, the same effect as the aforementioned embodiment can be obtained.

According to an embodiment of the present invention, a low sound based on a low frequency component in a center channel audio signal CAS can be emitted as if it is emitted from a thin center speaker CS, by a phenomenon that sounds are heard as the position is deviated to the direction where there is the sound reached to the ears at first (HAAS effect). Thereby, an audio control system in that even if it has a thin center speaker, low sounds can be felt to be heard from the center speaker can be realized.

It should be understood by those skilled in the art that various modifications, combinations, sub-combinations and alterations may occur depending on design requirements and other factors insofar as they are within the scope of the appended claims or the equivalents thereof.

What is claimed is:

1. An audio control system comprising:
audio input means for inputting a center channel audio signal, a left channel audio signal and a right channel audio signal in an audio source; and
output control means for controlling the output of said center channel audio signal to a center speaker, the output of said left channel audio signal to a left speaker, and the output of said right channel audio signal to a right speaker;
wherein said output control means includes
a first filter section extracting a high frequency signal from said center channel audio signal,
a second filter section extracting a low frequency signal from said center channel audio signal,
a first adding section adding said low frequency component extracted by said second filter section to said left channel audio signal, and
a second adding section adding said low frequency component extracted by said second filter section to said right channel audio signal.

2. The audio control system according to claim 1, wherein:
said output control means further includes a delay section delaying said low frequency signal extracted by said second filter section; and
said low frequency signal that was delayed for a predetermined delay time by said delay section is added to said left channel audio signal and said right channel audio signal in said first adding section and said second adding section, and the resultant signals are transmitted to the respectively corresponding left speaker and right speaker.

3. The audio control system according to claim 2, wherein;
said delay section provides setting means for setting said delay time, according to the distance between said center speaker and said left speaker, and the distance between said center speaker and said right speaker.

4. The audio control system according to claim 3, wherein;
said delay time set by said setting means is 2 msec to 10 msec.

5. An audio control system comprising:
an audio input section inputting a center channel audio signal, a left channel audio signal and a right channel audio signal in an audio source; and
an output control section controlling the output of said center channel audio signal to a center speaker, the output of said left channel audio signal to a left speaker, and the output of said right channel audio signal to a right speaker;
wherein said output control section includes
a first filter section extracting a high frequency signal from said center channel audio signal,
a second filter section extracting a low frequency signal from said center channel audio signal,
a first adding section adding said low frequency component extracted by said second filter section to said left channel audio signal, and
a second adding section adding said low frequency component extracted by said second filter section to said right channel audio signal.
